(19) United States
(12) Patent Application Publication
(10) Pub. No.: US 2026/0360297 A1
(43) Pub. Date: Nov. 12, 2026

(54) GATE DRIVING CIRCUIT, DISPLAY PANEL, AND DISPLAY DEVICE

(71) Applicant: Tianma Microelectronics Co.,Ltd., Shenzhen (CN)

(72) Inventors: Jiahui YE, Shenzhen (CN); Sungwook CHANG, Shenzhen (CN); Sangwon LEE, Shenzhen (CN); Qiuyi LIN, Shenzhen (CN)

(73) Assignee: Tianma Microelectronics Co.,Ltd., Shenzhen (CN)

(21) Appl. No.: 19/719,739

(22) Filed: Jun. 25, 2026

(30) Foreign Application Priority Data
Nov. 27, 2025 (CN) 202511766981.5

(51) Int. Cl. G09G 3/20

(52) U.S. Cl. CPC G09G 3/2092; G09G 2310/0267; G09G 2310/0286; G09G 2320/043

(57) ABSTRACT

Provided are a gate driving circuit, a display panel, and a display device. The gate driving circuit includes multiple cascaded shift registers, and a shift register includes an input unit, a sustain unit, and an output unit. An output terminal of the input unit and a first control terminal of the output unit are connected to a first node. A first terminal of the sustain unit is connected to the first node, and a second terminal of the sustain unit and an input terminal of the output unit are connected to a second node. The sustain unit and/or the output unit includes a combination unit including a first branch transistor and a second branch transistor. A gate of the first branch transistor is connected to a first clock signal terminal, and a gate of the second branch transistor is connected to a second clock signal terminal.

### CROSS-REFERENCE TO RELATED APPLICATION(S)

This application claims priority of a Chinese Patent Application filed with China National Intellectual Property Administration (CNIPA) on Nov. 27, 2025, with application No. 202511766981.5, the disclosure of which is incorporated herein by reference in its entirety.

### TECHNICAL FIELD

The present disclosure relates to the technical field of display, in particular to a gate driving circuit, a display panel, and a display device.

### BACKGROUND

A gate driver on array (GOA) circuit is typically constructed using a low-temperature polycrystalline silicon thin-film transistor. Due to its excellent positive bias temperature stress (PBTS) and excellent negative bias temperature stress (NBTS), the low-temperature polycrystalline silicon thin-film transistor can remain stable under long-term driving at a high temperature.

### SUMMARY

The present disclosure provides a gate driving circuit, a display panel, and a display device to prolong the service life of a shift register and prolong the service life of the gate driving circuit.

In a first aspect, the embodiments of the present disclosure provide a gate driving circuit including multiple cascaded shift registers. A shift register includes an input unit, a sustain unit, and an output unit.

An output terminal of the input unit and a first control terminal of the output unit are connected to a first node, a first terminal of the sustain unit is connected to the first node, and a second terminal of the sustain unit and an input terminal of the output unit are connected to a second node.

The sustain unit and/or the output unit includes a combination unit. The combination unit includes a first branch transistor and a second branch transistor. A gate of the first branch transistor is connected to a first clock signal terminal, and a gate of the second branch transistor is connected to a second clock signal terminal.

In a second aspect, the embodiments of the present disclosure provide a gate driving circuit including multiple cascaded shift registers. A shift register includes an input unit, a sustain unit, and an output unit.

An output terminal of the input unit and a first control terminal of the output unit are connected to a first node, a first terminal of the sustain unit is connected to the first node, and a second terminal of the sustain unit and an input terminal of the output unit are connected to a second node.

Any one of the input unit, the sustain unit, and the output unit includes at least one transistor, and in the shift register, a quantity proportion of transistors whose gates are connected to clock signal terminals exceeds 50%.

In a third aspect, the embodiments of the present disclosure provide a display panel including the gate driving circuit described in the first aspect or the second aspect.

In a fourth aspect, the embodiments of the present disclosure provide a display device including the display panel described in the third aspect.

### BRIEF DESCRIPTION OF DRAWINGS

FIG. 1 is a schematic diagram of a threshold voltage offset curve of a transistor.

FIG. 2 is a circuit diagram of a gate driving circuit according to an embodiment of the present disclosure.

FIG. 3 is a circuit diagram of a shift register according to an embodiment of the present disclosure.

FIG. 4 is a circuit diagram of a shift register according to an embodiment of the present disclosure.

FIG. 5 is a circuit diagram of a shift register according to an embodiment of the present disclosure.

FIG. 6 is a circuit diagram of a shift register according to an embodiment of the present disclosure.

FIG. 7 is a circuit diagram of a shift register according to an embodiment of the present disclosure.

FIG. 8 is a circuit diagram of a shift register according to an embodiment of the present disclosure.

FIG. 9 is another circuit diagram of a gate driving circuit according to an embodiment of the present disclosure.

FIG. 10 is a circuit diagram of a shift register according to an embodiment of the present disclosure.

FIG. 11 is a circuit diagram of a shift register according to an embodiment of the present disclosure.

FIG. 12 is a circuit diagram of a shift register according to an embodiment of the present disclosure.

FIG. 13 is a circuit diagram of a shift register according to an embodiment of the present disclosure.

FIG. 14 is a circuit diagram of a shift register according to an embodiment of the present disclosure.

FIG. 15 is another circuit diagram of a gate driving circuit according to an embodiment of the present disclosure.

FIG. 16 is another circuit diagram of a gate driving circuit according to an embodiment of the present disclosure.

FIG. 17 is a driving timing diagram according to an embodiment of the present disclosure.

FIG. 18 is a circuit diagram of a shift register according to an embodiment of the present disclosure.

FIG. 19 is another driving timing diagram according to an embodiment of the present disclosure.

FIG. 20 is another driving timing diagram according to an embodiment of the present disclosure.

FIG. 21 is another driving timing diagram according to an embodiment of the present disclosure.

FIG. 22 is another driving timing diagram according to an embodiment of the present disclosure.

FIG. 23 is a schematic diagram of a display panel according to an embodiment of the present disclosure.

FIG. 24 is a schematic diagram of a display device according to an embodiment of the present disclosure.

### DETAILED DESCRIPTION

The present disclosure will be further described hereinafter in conjunction with drawings and embodiments. It can be understood that the embodiments described herein are intended to illustrate and not to limit the present disclosure. It should also be noted that, for ease of description, only a part, not all, related to the present disclosure is illustrated in the drawings.

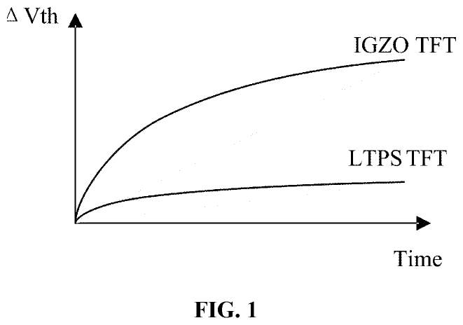

An indium gallium zinc oxide (IGZO) transistor has advantages such as high mobility and low leakage current. FIG. 1 is a schematic diagram of a threshold voltage shift curve of a transistor. Referring to FIG. 1, ΔVth represents a shift degree of the threshold voltage of the transistor, IGZO TFT represents the indium gallium zinc oxide transistor, and LTPS TFT represents a low-temperature polycrystalline silicon thin-film transistor. The indium gallium zinc oxide transistor exhibits poor PBTS characteristics, and during long-term high temperature driving, the threshold voltage (Vth) of some indium gallium zinc oxide transistors may experience a positive drift, resulting in circuit failure.

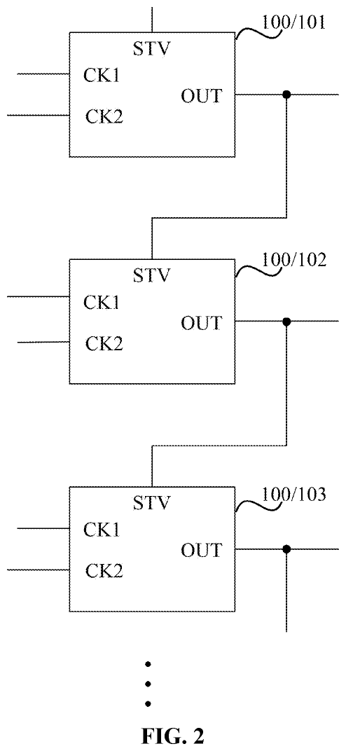

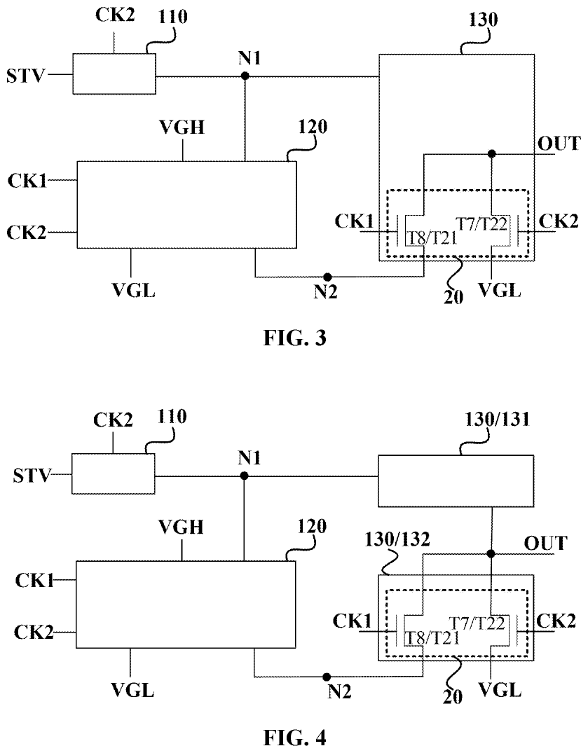

FIG. 2 is a circuit diagram of a gate driving circuit according to an embodiment of the present disclosure. FIG. 3 is a circuit diagram of a shift register according to an embodiment of the present disclosure. Referring to FIGS. 2 and 3, the gate driving circuit includes multiple cascaded shift registers 100. A shift register 100 includes an input unit 110, a sustain unit 120, and an output unit 130. An output terminal of the input unit 110 is connected to a first node N1, a first control terminal of the output unit 130 is connected to the first node N1, a first terminal of the sustain unit 120 is connected to the first node N1, a second terminal of the sustain unit 120 is connected to a second node N2, and an input terminal of the output unit 130 is connected to the second node N2. The sustain unit 120 includes a combination unit 20, and the combination unit 20 includes a first branch transistor T21 and a second branch transistor T22. A gate of the first branch transistor T21 is connected to a first clock signal terminal CK1, and a gate of the second branch transistor T22 is connected to a second clock signal terminal CK2. In other implementations, the output unit 130 may include the combination unit 20; alternatively, both the sustain unit 120 and the output unit 130 may include the combination unit 20. Nodes (including the first node N1, the second node N2, and the third node N3) in various embodiments of the present disclosure may be actual physical connection points or virtual connection points.

The embodiments of the present disclosure employ the combination unit 20. The gate of the first branch transistor T21 is connected to the first clock signal terminal CK1, and the first branch transistor T21 is controlled to be turned on or off by the first clock signal terminal CK1. The gate of the second branch transistor T22 is connected to the second clock signal terminal CK2, and the second branch transistor T22 is controlled to be turned on or off by the second clock signal terminal CK2. The first clock signal terminal CK1 and the second clock signal terminal CK2 provide different clock signals, respectively. The high-level period of the first clock signal terminal CK1 is spaced apart from the high-level period of the second clock signal terminal CK2. The signal provided by the first clock signal terminal is a transition signal. The duration ratio of the high-level signals received by the gate of the first branch transistor T21 is less than 50%. The signal provided by the second clock signal terminal CK2 is a transition signal. The duration ratio of the high-level signals received by the gate of the second branch transistor T22 is less than 50%. In this manner, the duration of PBTS on the first branch transistor T21 and on the second branch transistor T22 is reduced, thereby prolonging the service life of the shift register and the service life of the gate driving circuit.

Referring to FIGS. 2 and 11, the gate driving circuit includes multiple cascaded shift registers 100. A shift register 100 includes the input unit 110, the sustain unit 120, and the output unit 130. The output terminal of the input unit 110 and the first control terminal of the output unit 130 are connected to the first node N1. The first terminal of the sustain unit 120 is connected to the first node N1. The second terminal of the sustain unit 120 and the input terminal of the output unit 130 are connected to the second node N2. Any one of the input unit 110, the sustain unit 120, and the output unit 130 includes at least one transistor. In the multiple shift registers 100, a quantity proportion of transistors whose gates are connected to clock signal terminals (including the first clock signal terminal CK1 and the second clock signal terminal CK2) exceeds 50%.

In an example, referring to FIG. 11, in the present disclosure, gates of three transistors among the nine transistors (treating a double-gate transistor as one transistor) are not connected to the clock signal terminals, and gates of the other six transistors are connected to the clock signal terminals. The quantity proportion of transistors whose gates are connected to the clock signal terminals is relatively large, exceeding 50%. Since the signals from the clock signal terminals are transitional clock signals, the duration ratio of the high-level signals received by gates of the transistors is less than 50%. The quantity of transistors subjected to long-term PBTS is reduced, and the quantity of transistors whose gates are connected to the clock signal terminals is increased, thereby prolonging the service life of the shift register and the service life of the gate driving circuit.

A certain time interval exists between the high-level period of the first clock signal terminal CK1 and the high-level period of the second clock signal terminal CK2. Even if only the first clock signal terminal CK1 and the second clock signal terminal CK2 are used, instead of using two of at least three clock signals, the duration ratio of the high-level signal of the first clock signal terminal CK1 is less than 50%, and the duration ratio of the high-level signal of the second clock signal terminal CK2 is less than 50%.

Referring to FIG. 3, a first electrode of the first branch transistor T21 is coupled to a first electrode of the second branch transistor T22, and a second electrode of the second branch transistor T22 is connected to a first power supply voltage terminal VGL. When the second branch transistor T22 is controlled to be turned on by the second clock signal terminal CK2, a low level of the first power supply voltage terminal VGL is transmitted to the first electrode of the second branch transistor T22. When the first branch transistor T21 is controlled to be turned on by the first clock signal terminal CK1, a high level or a low level is transmitted to the first electrode of the first branch transistor T21. The first branch transistor T21 and the second branch transistor T22 jointly control the connection point where the first branch transistor T21 is coupled to the second branch transistor T22, and the voltage of the connection point is configured to be a low level for a long time. The term “long time” in various embodiments of the present disclosure refers to a large duration ratio, where the large duration ratio exceeds 50%. The term “couple” refers to a direct or indirect electrical connection, and the indirect electrical connection means that at least one functional element is provided between coupled components. The term “connection” in various embodiments of the present disclosure refers to a direct electrical connection, and no functional element exists between directly connected components.

FIG. 4 is a circuit diagram of a shift register according to an embodiment of the present disclosure. Referring to FIG. 4, the output unit 130 includes a first output unit 131 and a second output unit 132, and a control terminal of the first output unit 131 is connected to the first node N1. The second output unit 132 includes a first output transistor T8 and a second output transistor T7. The first output transistor T8 is the first branch transistor T21, and the second output transistor T7 is the second branch transistor T22. An output terminal of the first output unit 131 is connected to an output signal terminal OUT, and both a first electrode of the first output transistor T8 and a first electrode of the second output transistor T7 are connected to the output signal terminal OUT.

Referring to FIG. 4, the second output unit 132 includes the first output transistor T8 and the second output transistor T7. The duration ratio of the high-level signal received by the gate of the first output transistor T8 is less than 50%, and the duration ratio of the high-level signals received by the gate of the second output transistor T7 is less than 50%, thereby prolonging the service life of the shift register and the service life of the gate driving circuit.

Referring to FIG. 4, a second electrode of the first output transistor T8 is connected to the second node N2. When the first output transistor T8 is controlled to be turned on by the first clock signal terminal CK1, the high level or the low level of the second node N2 is transmitted to the output signal terminal OUT.

In an example, referring to FIG. 4, the first electrode of the first output transistor T8 is connected to the output signal terminal OUT, and the second electrode of the first output transistor T8 is connected to the second node N2. The first electrode of the second output transistor T7 is connected to the output signal terminal OUT, and the second electrode of the second output transistor T7 is connected to the first power supply voltage terminal VGL. The signal at the first clock signal terminal CK1 and the signal at the second clock signal terminal CK2 are complementary signals, enabling the first output transistor T8 and the second output transistor T7 to be alternately turned on, thus configuring the output signal terminal OUT to be at the low level for a long time.

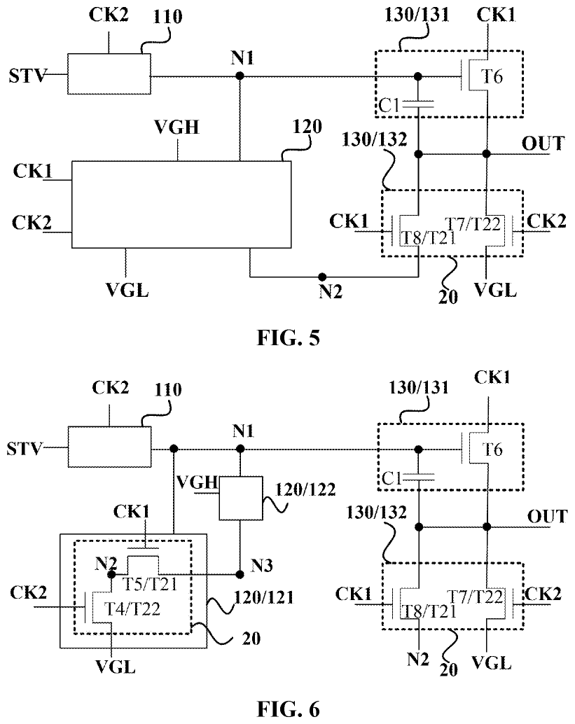

FIG. 5 is a circuit diagram of a shift register according to an embodiment of the present disclosure. Referring to FIG. 5, the first output unit 131 includes a third output transistor T6 and a first capacitor C1. A gate of the third output transistor T6 is connected to the first node N1, a first electrode of the third output transistor T6 is connected to the first clock signal terminal CK1, and a second electrode of the third output transistor T6 is connected to the output signal terminal OUT. A first plate of the first capacitor C1 is connected to the first node N1, and a second plate of the first capacitor C1 is connected to the output signal terminal OUT. Under a bootstrapping effect of the first capacitor C1, the first node N1 is coupled to a higher voltage, allowing the third output transistor T6 to be completely turned on. The third output transistor T6 has a better voltage transmission capability. The high level of the first clock signal terminal CK1 is transmitted to the output signal terminal OUT, and the output signal terminal OUT outputs a high level (an effective level or an enable level).

FIG. 6 is a circuit diagram of a shift register according to an embodiment of the present disclosure. Referring to FIG. 6, the sustain unit 120 includes a first sustain unit 121. The first sustain unit 121 includes a first sustain transistor T5 and a second sustain transistor T4. The first sustain transistor T5 is the first branch transistor T21, and the second sustain transistor T4 is the second branch transistor T22. A first electrode of the first sustain transistor T5 and a first electrode of the second sustain transistor T4 are connected to the second node N2.

Referring to FIG. 6, the duration ratio of the high-level signal received by a gate of the first sustain unit 121 is less than 50%, and the duration ratio of the high-level signal received by a gate of the second sustain transistor T4 is less than 50%, thereby prolonging the service life of the shift register and the service life of the gate driving circuit.

Referring to FIG. 6, a second electrode of the second sustain transistor T4 is connected to the first power supply voltage terminal VGL. When the second sustain transistor T4 is controlled to be turned on by the second clock signal terminal CK2, the low level of the first power supply voltage terminal VGL is transmitted to the second node N2. The first electrode of the first sustain transistor T5 is connected to the second node N2, and the second electrode of the first sustain transistor T5 is connected to the third node N3. The first electrode of the second sustain transistor T4 is connected to the second node N2, and the second electrode of the second sustain transistor T4 is connected to the first power supply voltage terminal VGL. The signal at the first clock signal terminal CK1 and the second clock signal terminal CK2 are complementary signals, enabling the first sustain transistor T5 and the second sustain transistor T4 to be alternately turned on, thus configuring the second node N2 to be at the low level for a long time.

Referring to FIG. 6, the second electrode of the first sustain transistor T5 is coupled to the first node N1. Therefore, when the first sustain transistor T5 is controlled to be turned on by the first clock signal terminal CK1, the first node N1 is connected to the second node N2, and the voltage of the second node N2 is pulled down to the low level by the voltage of the first node N1, or the voltage of the first node N1 is pulled down to the low level by the voltage of the second node N2.

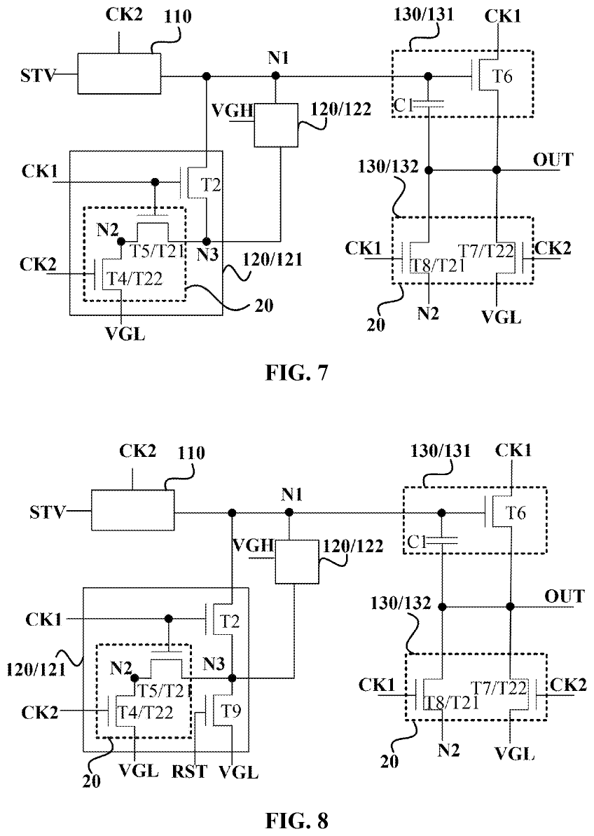

FIG. 7 is a circuit diagram of a shift register according to an embodiment of the present disclosure. Referring to FIG. 7, the first sustain unit 121 further includes a third sustain transistor T2. A first electrode of the third sustain transistor T2 is connected to the third node N3, the second electrode of the first sustain transistor T5 is connected to the third node N3, and a second electrode of the third sustain transistor T2 is connected to the first node N1, and a gate of the third sustain transistor T2 is connected to the first clock signal terminal CK1.

Referring to FIG. 7, the second electrode of the first sustain transistor T5 is connected to the third node N3. The second electrode of the first sustain transistor T5 is electrically connected to the first electrode of the third sustain transistor T2. The second electrode of the first sustain transistor T5 is indirectly connected to the first node N1 through the third sustain transistor T2. When the third sustain transistor T2 is turned on, the second electrode of the first sustain transistor T5 is electrically connected to the first node N1. Without considering the voltage drop caused by the third sustain transistor T2, the second electrode of the first sustain transistor T5 and the first node N1 have the same voltage level.

FIG. 8 is a circuit diagram of a shift register according to an embodiment of the present disclosure. Referring to FIG. 8, the first sustain unit 121 further includes a reset transistor T9, a first electrode of the reset transistor T9 is connected to the first power supply voltage terminal VGL, and a second electrode of the reset transistor T9 is connected to the third node N3. When the reset transistor T9 is turned on, the low level of the first power supply voltage terminal VGL is transmitted to the third node N3 to prevent the third node N3 from floating when the third sustain transistor T2 and the first sustain transistor T5 are turned off. The voltage of the third node N3 is configured to be a low level so that when the first sustain transistor T5 is controlled to be turned on by the first clock signal terminal CK1, the low level of the third node N3 is transmitted to the first node N1 to keep the voltage of the first node N1 at the low level. The voltage of the second node N2 quickly returns to the low level when the second sustain transistor T4 is turned on.

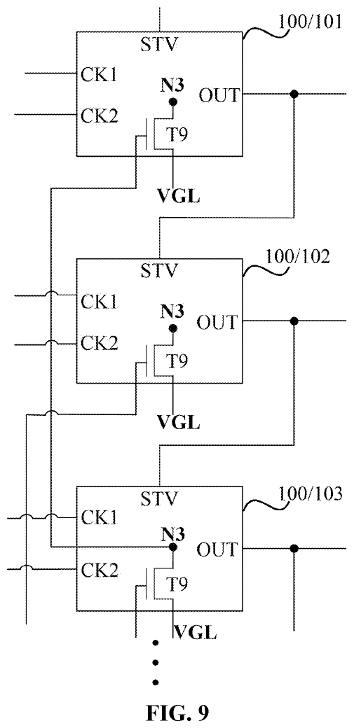

FIG. 9 is another circuit diagram of a gate driving circuit according to an embodiment of the present disclosure. Referring to FIGS. 8 and 9, a gate of the reset transistor T9 is connected to a reset signal terminal RST. The reset signal terminal RST of an i-th shift register 100 is connected to the third node N3 of an (i+2)-th shift register 100, and i is a positive integer. In other words, the gate of the reset transistor T9 of the shift register 100 at the current stage is connected to the third node N3 of the shift register 100 at the stage after the next stage. Therefore, the reset transistor T9 of the i-th shift register 100 is controlled to be turned on or off by the third node N3 of the (i+2)-th shift register 100.

In an example, referring to FIG. 9, the multiple shift registers 100 include a first shift register 101, a second shift register 102 and a third shift register 103 which are cascaded. The gate of the reset transistor T9 of the first shift register 101 is connected to the third node N3 of the third shift register 103.

In an example, at least two last stages of the multiple shift registers 100 may be used as dummy registers that do not output signals, and the at least two last stages of shift registers 100 are configured to provide control signals for the gates of the reset transistors T9 in the shift registers 100 at the last two stages that output signals. For example, a j-th shift register 100 is the last stage of shift register 100 that outputs a signal, and a (j+1)-th shift register 100 and a (j+2)-th shift register 100 do not output signals. The (j+2)-th shift register 100 aims to provide the control signal to the gate of the reset transistor T9 in the j-th shift register 100 to ensure the normal operation of the j-th shift register 100, and j is a positive integer greater than i. The “output a signal” here means that the output signal terminal OUT is connected to a scanning line and transmits the signal to the scanning line for controlling the transistor in the pixel driving circuit to be turned on or off. The “does not output a signal” here means that the output signal terminal OUT is not connected to the scanning line and is not used to control the transistor in the pixel driving circuit to be turned on or off.

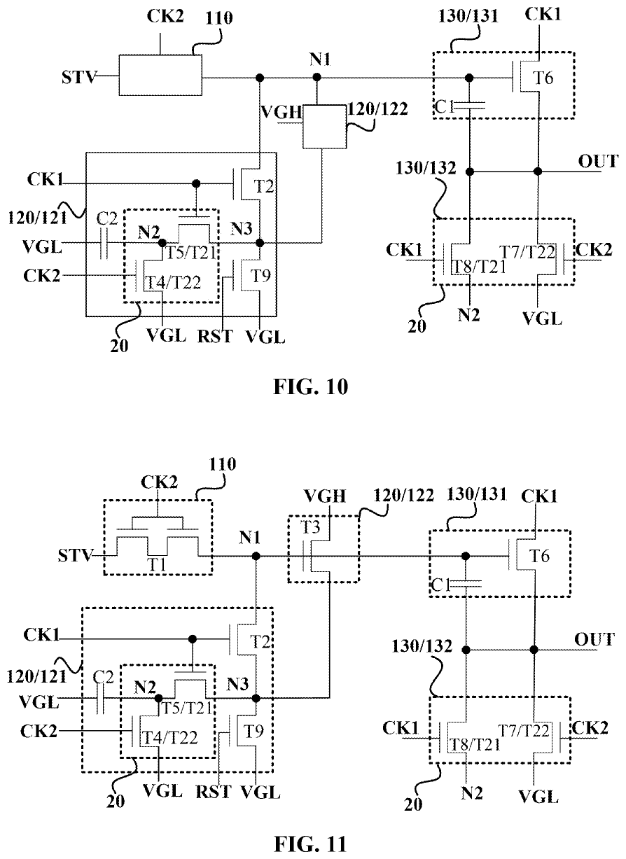

FIG. 10 is a circuit diagram of a shift register according to an embodiment of the present disclosure. Referring to FIG. 10, the first sustain unit 121 further includes a second capacitor C2, a first plate of the second capacitor C2 is connected to the first power supply voltage terminal VGL, and a second plate of the second capacitor C2 is connected to the second node N2. The second capacitor C2 is used to keep the voltage of the second node N2 stable and reduce the disturbance of the voltage of the second node N2 caused by the voltage jump of the first clock signal terminal CK1 and the second clock signal terminal CK2.

Referring to FIG. 10, the sustain unit 120 further includes a second sustain unit 122, a control terminal of the second sustain unit 122 is coupled to the first node N1, an input terminal of the second sustain unit 122 is connected to a second power supply voltage terminal VGH, and an output terminal of the second sustain unit 122 is coupled to the second node N2. When the second sustain unit 122 is controlled to be turned on by the first node N1, the high level of the second power supply voltage terminal VGH is transmitted to the second node N2, and the voltage of the second node N2 is pulled up.

In an example, referring to FIG. 10, when the first node N1 is at a high level, the third output transistor T6 is turned on to transmit the high level of the first clock signal terminal CK1 to the output signal terminal OUT, and the output signal terminal OUT outputs a high level. When the first node N1 is at a high level, the second sustain unit 122 is turned on to transmit the high level of the second power supply voltage terminal VGH to the second node N2. The first output transistor T8 is controlled to be turned on by the high level of the first clock signal terminal CK1, and the high level of the second node N2 is transmitted to the output signal terminal OUT. On the one hand, a conflict between voltages (for example, the voltage written to the output signal terminal OUT through the third output transistor T6 is at a high level, and the voltage written to the output signal terminal OUT through the first output transistor T8 is at a low level) is avoided, thus ensuring the normal operation of the shift register and the gate driving circuit. On the other hand, the high level is simultaneously provided to the output signal terminal OUT through two paths, thus enhancing the driving capability of the output signal terminal OUT.

FIG. 11 is a circuit diagram of a shift register according to an embodiment of the present disclosure. Referring to FIG. 11, the second sustain unit 122 includes a fourth sustain transistor T3, a gate of the fourth sustain transistor T3 is connected to the first node N1, a first electrode of the fourth sustain transistor T3 is connected to the second power supply voltage terminal VGH, and a second electrode of the fourth sustain transistor T3 is connected to a third node N3. The second electrode of the first sustain transistor T5 is connected to the third node N3. The second electrode of the fourth sustain transistor T3 is connected to the first electrode of the third sustain transistor T2.

In an example, referring to FIG. 11, when the first node N1 and the first clock signal terminal CK1 are at a high level, the third sustain transistor T2 and the first sustain transistor T5 are turned on to transmit the high level of the first node N1 to the second node N2.

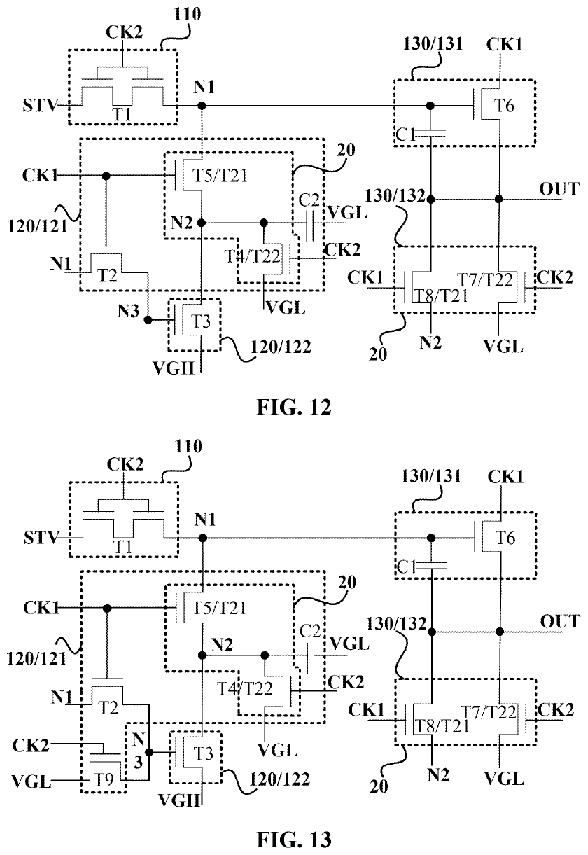

FIG. 12 is a circuit diagram of a shift register according to an embodiment of the present disclosure. Referring to FIG. 12, the second sustain unit 122 includes a fourth sustain transistor T3, a gate of the fourth sustain transistor T3 is connected to the third node N3, a first electrode of the fourth sustain transistor T3 is connected to the second power supply voltage terminal VGH, and a second electrode of the fourth sustain transistor T3 is connected to the second node N2. The first electrode of the first sustain transistor T5 is connected to the second node N2.

In an example, referring to FIG. 12, when the first node N1 and the first clock signal terminal CK1 are at high levels, the third sustain transistor T2 is turned on to transmit the high level of the first node N1 to the third node N3. In this case, the fourth sustain transistor T3 is controlled to be turned on by the third node N3, and the high level of the second power supply voltage terminal VGH is transmitted to the second node N2.

In an example, referring to FIG. 12, the first sustain unit 121 further includes the third sustain transistor T2, the first electrode of the third sustain transistor T2 is connected to the third node N3, the second electrode of the first sustain transistor T5 is connected to the first node N1, the second electrode of the third sustain transistor T2 is connected to the first node N1, and the gate of the third sustain transistor T2 is connected to the first clock signal terminal CK1.

FIG. 13 is a circuit diagram of a shift register according to an embodiment of the present disclosure. Referring to FIG. 13, the first sustain unit 121 further includes the reset transistor T9, the first electrode of the reset transistor T9 is connected to the first power supply voltage terminal VGL, and the second electrode of the reset transistor T9 is connected to the third node N3. When the reset transistor T9 is turned on, the low level of the first power supply voltage terminal VGL is transmitted to the third node N3 to prevent the third node N3 from floating, and the voltage of the third node N3 is configured to be a low level.

Referring to FIG. 13, the gate of the reset transistor T9 is connected to the reset signal terminal RST, and the reset signal terminal RST is connected to the second clock signal terminal CK2. The reset transistor T9 is controlled to be turned on by the high level of the second clock signal terminal CK2, and the reset transistor T9 is controlled to be turned off by the low level of the second clock signal terminal CK2.

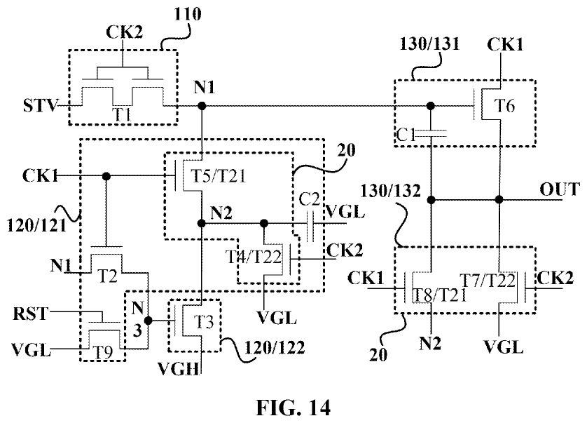

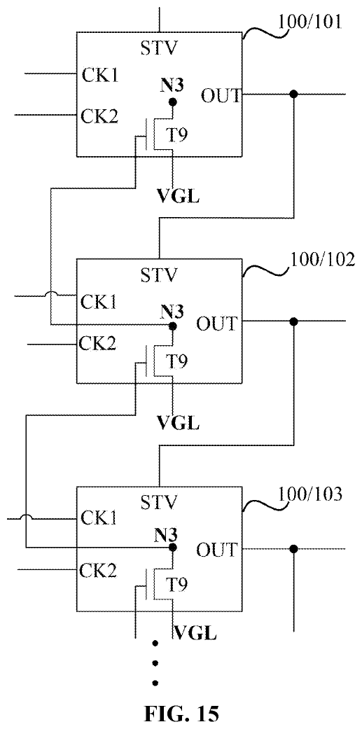

FIG. 14 is a circuit diagram of a shift register according to an embodiment of the present disclosure. FIG. 15 is another circuit diagram of a gate driving circuit according to an embodiment of the present disclosure. Referring to FIGS. 14 and 15, the reset signal terminal RST of an i-th shift register 100 is connected to the third node N3 of an (i+1)-th shift register 100, and i is a positive integer. In other words, the gate of the reset transistor T9 of the shift register 100 at the current stage is connected to the third node N3 of the shift register 100 at the next stage. Therefore, the reset transistor T9 of the i-th shift register 100 is controlled to be turned on or off by the third node N3 of the (i+1)-th shift register 100.

In an example, referring to FIG. 15, the multiple shift registers 100 include a first shift register 101, a second shift register 102 and a third shift register 103 which are cascaded. The gate of the reset transistor T9 of the first shift register 101 is connected to the third node N3 of the second shift register 102, and the gate of the reset transistor T9 of the second shift register 102 is connected to the third node N3 of the third shift register 103.

In an example, at least one last stage of the multiple shift registers 100 may be used as dummy registers that do not output signals, and the at least one last stage of shift registers 100 are configured to provide control signals for the gate of the reset transistor T9 in the shift register 100 at the last stage that outputs the signal. For example, a j-th shift register 100 is a shift register 100 at the last stage that outputs the signal, and a (j+1)-th shift register 100 does not output the signal. The (j+1)-th shift register 100 aims to provide the control signal to the gate of the reset transistor T9 in the j-th shift register 100 to ensure the normal operation of the j-th shift register 100, and j is a positive integer greater than i.

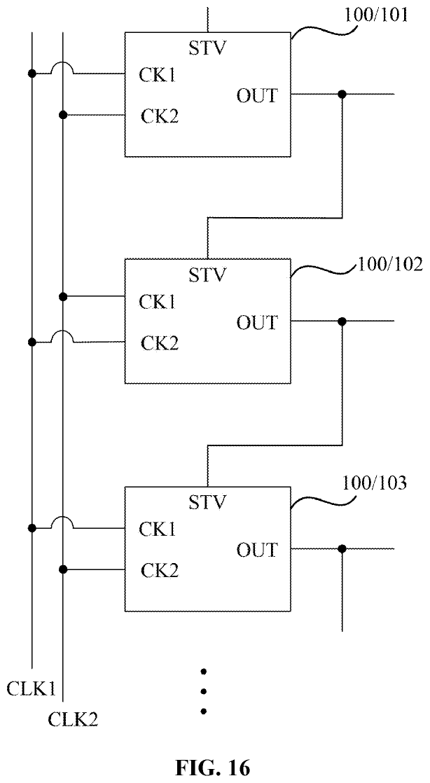

FIG. 16 is another circuit diagram of a gate driving circuit according to an embodiment of the present disclosure. Referring to FIGS. 11 and 16, the input terminal of the input unit 110 is connected to a cascade signal input terminal STV. The control terminal of the input unit 110 is connected to the second clock signal terminal CK2. The output signal terminal OUT of an i-th shift register 100 is connected to the cascade signal input terminal STV of an (i+1)-th shift register 100, and i is a positive integer. In the embodiments of the present disclosure, the multiple shift registers 100 are cascaded stage by stage. In other embodiments, the multiple shift registers 100 may be cascaded at intervals. For example, the output signal terminal OUT of an i-th shift register 100 is connected to the cascaded signal input terminal STV of an (i+2)-th shift register 100.

Referring to FIG. 11 or FIG. 13, the input unit 110 includes an input transistor T1, a gate of the input transistor T1 is connected to the second clock signal terminal CK2, a first electrode of the input transistor T1 is connected to the cascaded signal input terminal STV, and a second electrode of the input transistor T1 is connected to the first node N1. When the input transistor T1 is controlled to be turned on by the second clock signal terminal CK2, the voltage on the cascaded signal input terminal STV is transmitted to the first node N1.

In an example, the input transistor T1 is the double-gate transistor, i.e., two transistors connected in series whose gates are electrically connected to each other.

Referring to FIG. 16, the gate driving circuit further includes a first clock signal line CLK1 and a second clock signal line CLK2. The first clock signal line CLK1 is electrically connected to the first clock signal terminal CK1 of an i-th shift register 100 and the second clock signal terminal CK2 of an (i+1)-th shift register 100. The second clock signal line CLK2 is electrically connected to the second clock signal terminal CK2 of the i-th shift register 100 and the first clock signal terminal CK1 of the (i+1)-th shift register 100, and i is a positive integer. The first clock signal line CLK1 and the second clock signal line CLK2 provide clock signals for the clock signal terminals (including the first clock signal terminal CK1 and the second clock signal terminal CK2) connected thereto, respectively.

In an example, the first clock signal line CLK1 is electrically connected to the first clock signal terminal CK1 of the first shift register 101 and the second clock signal terminal CK2 of the second shift register 102. The second clock signal line CLK2 is electrically connected to the second clock signal terminal CK2 of the first shift register 101 and the first clock signal terminal CK1 of the second shift register 102.

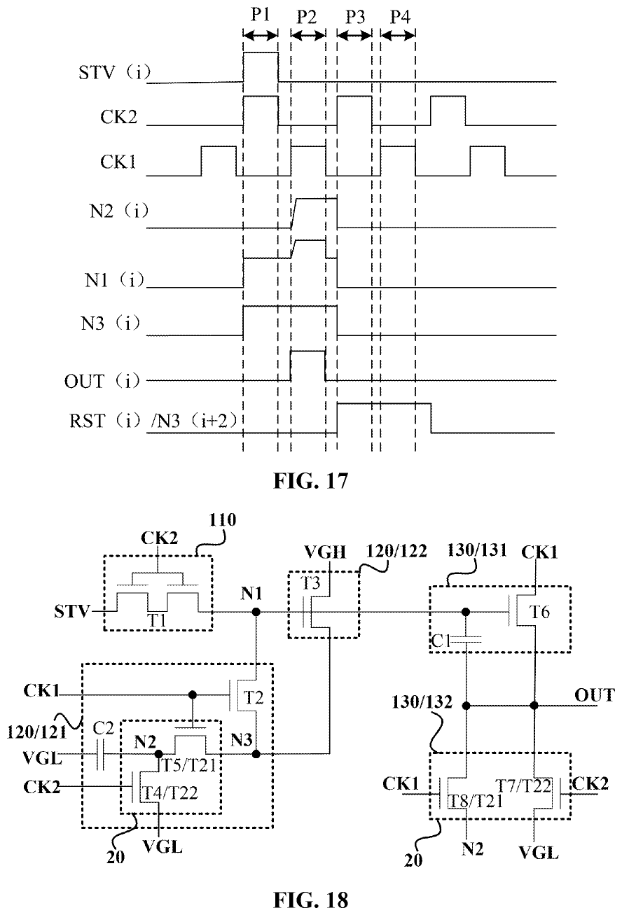

FIG. 17 is a driving timing diagram according to an embodiment of the present disclosure. Referring to FIGS. 11 and 17, taking an i-th shift register 100 as an example, the operation process of the shift register 100 in the gate driving circuit is described below. Specifically, the operation process includes the following:

In a first period P1, the first node N1 is precharged.

In the first period P1, the second clock signal terminal CK2 is at a high level, the input transistor T1 is turned on, and the high level of the cascaded signal input terminal STV is written to the first node N1. The third output transistor T6 is turned on, the low level of the first clock signal terminal CK1 is transmitted to the output signal terminal OUT through the third output transistor T6, and the output signal terminal OUT outputs a low level. The first node N1 is at a high level, the fourth sustain transistor T3 is turned on, and the high level of the second power supply voltage terminal VGH is written to the third node N3.

The first clock signal terminal CK1 is at a low level, the third sustain transistor T2 and the first sustain transistor T5 are turned off, the second clock signal terminal CK2 is at a high level, the second sustain transistor T4 is turned on, and the low level of the first power supply voltage terminal VGL is transmitted to the second node N2. The first clock signal terminal CK1 is at a low level, and the first output transistor T8 is turned off. The second clock signal terminal CK2 is at a high level, the second output transistor T7 is turned on, the low level of the first power supply voltage terminal VGL is transmitted to the output signal terminal OUT, and the output signal terminal OUT outputs a low level. The reset signal terminal RST is at a low level, and the reset transistor T9 is turned off.

In a second period P2, the capacitor bootstrapping is performed.

In the second period P2, the cascade signal input terminal STV is at a low level, the first clock signal terminal CK1 changes from a low level to a high level, and the second clock signal terminal CK2 is at a low level. The input transistor T1 is turned off. The first node N1 remains at a high level, the third output transistor T6 is turned on, the first clock signal terminal CK1 changes from a low level to a high level, and the output signal terminal OUT outputs a high level. Under the bootstrapping effect of the first capacitor C1, the first node N1 is coupled to a higher voltage, allowing the third output transistor T6 to be completely turned on. The higher the gate potential of the third output transistor T6 is, the more completely the third output transistor T6 is turned on, and the stronger the voltage transmission capability is. In this case, the output signal terminal OUT outputs a high level (an effective level or an enable level).

The first node N1 remains at a high level, the fourth sustain transistor T3 is turned on, and the high level of the second power supply voltage terminal VGH is written to the third node N3. The voltage of the third node N3 remains at a high level. The first clock signal terminal CK1 changes from a low level to a high level, however, the second electrode of the third sustain transistor T2 is connected to the first node N1, the first node N1 is at the high level (the first node N1 is already at the high level in the first period P1), and the third sustain transistor T2 is not turned on by a gate-source voltage difference of the third sustain transistor T2, so the third sustain transistor T2 is at an off state. The voltage of the second node N2 is at a low level in the first period P1 and is pulled up to a high level in the second period P2. However, the charging and discharging process of the second node N2 takes a certain time (as shown by the sloping rising edge in the figure), and the first sustain transistor T5 is turned on by the high level of the first clock signal terminal CK1. The high level of the voltage of the third node N3 is transmitted to the second node N2 through the first sustain transistor T5, and the voltage of the second node N2 is pulled up to a high level. The fourth sustain transistor T3 keeps the voltage of the third node N3 at a high level. Therefore, the voltage of the third node N3 is not affected by the bootstrapping effect of the capacitor.

The second clock signal terminal CK2 is at a low level, and the second sustain transistor T4 and the second output transistor T7 are turned off. The reset signal terminal RST is at a low level, and the reset transistor T9 is turned off. The first clock signal terminal CK1 is at a high level, the first output transistor T8 is turned on, the high level of the second node N2 is transmitted to the output signal terminal OUT, and the output signal terminal OUT outputs a high level. The first clock signal terminal CK1 is at a high level, and the first sustain transistor T5 is turned on. In this case, the voltage of the second node N2 is at a high level, and the output of the output signal terminal OUT is not affected.

In a third period P3, a reset is performed.

In the third period P3, the second clock signal terminal CK2 is at a high level, the input transistor T1 is turned on, the low level of the cascaded signal input terminal STV is transmitted to the first node N1, and the voltage of the first node N1 is pulled down. The fourth sustain transistor T3 and the third output transistor T6 are turned off. The reset signal terminal RST changes from a low level to a high level, the reset transistor T9 is turned on, and the low level of the first power supply voltage terminal VGL is written to the third node N3. The third node N3 is not floating, and the reset transistor T9 keeps the voltage of the third node N3 at a low level.

The first clock signal terminal CK1 is at a low level, and the third sustain transistor T2, the first sustain transistor T5 and the first output transistor T8 are turned off. The second clock signal terminal CK2 is at a high level, the second sustain transistor T4 is turned on, the low level of the first power supply voltage terminal VGL is written to the second node N2, and the second node N2 changes from a high level to a low level. The second clock signal terminal CK2 is at a high level, the second output transistor T7 is turned on, the low level of the first power supply voltage terminal VGL is transmitted to the output signal terminal OUT, and the output signal terminal OUT outputs a low level.

In a fourth period P4, the low level remains.

In the fourth period P4, the cascade signal input terminal STV is at a low level, the first clock signal terminal CK1 is at a high level, and the second clock signal terminal CK2 is at a low level. The third sustain transistor T2 and the first sustain transistor T5 are turned on, and the low level already supplied to the second node N2 and the third node N3 is supplied to the first node N1, thus keeping the first node N1 at a low level stably. The fourth sustain transistor T3 and the third output transistor T6 are turned off.

The first clock signal terminal CK1 is at a high level, the first output transistor T8 is turned on, and the low level originally supplied to the second node N2 is supplied to the output signal terminal OUT, thus keeping the output signal terminal OUT at a low level stably.

The second clock signal terminal CK2 is at a low level, and the input transistor T1, the second sustain transistor T4 and the second output transistor T7 are turned off. The reset signal terminal RST remains at a high level, the reset transistor T9 is turned on, and the low level of the first power supply voltage terminal VGL is written to the third node N3. The voltage of the first node N1, the voltage of the second node N2, and the voltage of the third node N3 remain at a low level.

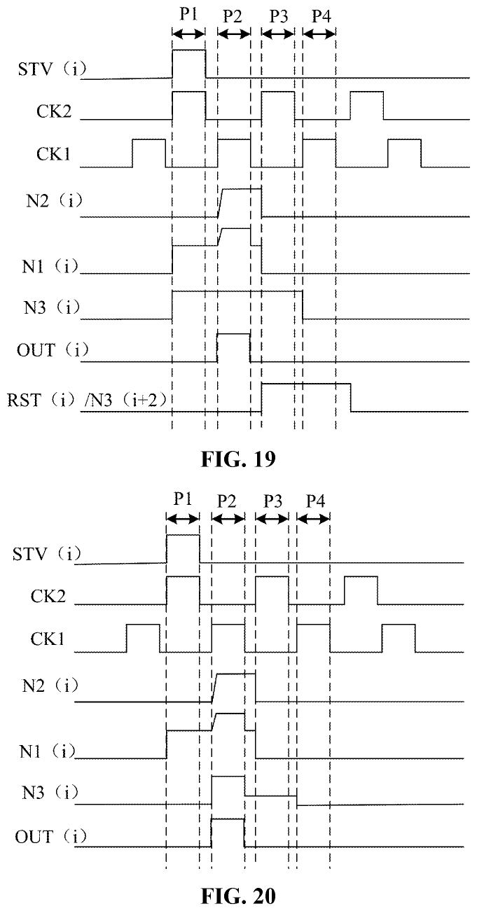

FIG. 18 is a circuit diagram of a shift register according to an embodiment of the present disclosure. FIG. 19 is another driving timing diagram according to an embodiment of the present disclosure. Compared with the shift register shown in FIG. 11, the reset transistor T9 is omitted in FIG. 18. For similarities, reference can be made to the above description of the operation process of the shift register shown in FIG. 11. The operation process of some transistors after the reset transistor T9 is omitted will be mainly described here.

Referring to FIGS. 18 and 19, in the first period P1, the first clock signal terminal CK1 is at a low level, and the third sustain transistor T2 and the first sustain transistor T5 are turned off. The second clock signal terminal CK2 is at a high level, the input transistor T1 is turned on, and the high level of the cascade signal input terminal STV is written to the first node N1. The second clock signal terminal CK2 is at a high level, the second sustain transistor T4 is turned on, and the low level of the first power supply voltage terminal VGL is transmitted to the second node N2. The first node N1 is at a high level, the fourth sustain transistor T3 is turned on, and the high level of the second power supply voltage terminal VGH is written to the third node N3.

In the second period P2, the first clock signal terminal CK1 changes from a low level to a high level. However, the third sustain transistor T2 is at the off state since the third sustain transistor T2 is not turned on by the gate-source voltage difference of the third sustain transistor T2. The first node N1 remains at a high level, the fourth sustain transistor T3 is turned on, and the high level of the second power supply voltage terminal VGH is written to the third node N3. The first sustain transistor T5 is turned on. The high level of the voltage of the third node N3 is transmitted to the second node N2 through the first sustain transistor T5, the second clock signal terminal CK2 is at a low level, and the second sustain transistor T4 is turned off.

In the third period P3, the first clock signal terminal CK1 is at a low level, and the third sustain transistor T2 and the first sustain transistor T5 are turned off. The second clock signal terminal CK2 is at a high level, the input transistor T1 is turned on, the low level of the cascaded signal input terminal STV is transmitted to the first node N1, and the voltage of the first node N1 is pulled down. The fourth sustain transistor T3 is turned off. The third node N3 is floating, the second clock signal terminal CK2 is at a high level, the second sustain transistor T4 is turned on, and the low level of the first power supply voltage terminal VGL is written into the second node N2.

In the fourth period P4, the first clock signal terminal CK1 is at a high level, the third sustain transistor T2 and the first sustain transistor T5 are turned on, the low level of the first node N1 is transmitted to the third node N3, and the low level of the second node N2 is transmitted to the third node N3. The voltage of the third node N3 is pulled down to a low level. The fourth sustain transistor T3 is turned off.

FIG. 20 is another driving timing diagram according to an embodiment of the present disclosure. Compared with the timing diagram shown in FIG. 17, the timing diagram of the reset signal terminal RST is omitted in FIG. 20. For similarities, reference can be made to the above description of the operation process of the shift register shown in FIG. 11, and the operation process of some transistors will be mainly described here.

Referring to FIGS. 12 and 20, in the first period P1, the first clock signal terminal CK1 is at a low level, and the third sustain transistor T2 and the first sustain transistor T5 are turned off. The second clock signal terminal CK2 is at a high level, the input transistor T1 is turned on, and the high level of the cascade signal input terminal STV is written to the first node N1. The second clock signal terminal CK2 is at a high level, the second sustain transistor T4 is turned on, and the low level of the first power supply voltage terminal VGL is transmitted to the second node N2. The third node N3 is floating, and the voltage of the third node N3 is at a low level.

In the second period P2, the first clock signal terminal CK1 is at a high level. However, the first sustain transistor T5 is at the off state since the first sustain transistor T5 is not turned on by the gate-source voltage difference of the first sustain transistor T5. The third sustain transistor T2 is turned on. The high level of the first node N1 is transmitted to the third node N3, the fourth sustain transistor T3 is turned on, the high level of the second power supply voltage terminal VGH is transmitted to the second node N2, and the voltage of the second node N2 is pulled up to a high level.

In the third period P3, the first clock signal terminal CK1 is at a low level, and the third sustain transistor T2 and the first sustain transistor T5 are turned off. The third node N3 is floating, the voltage of the third node N3 decreases after the falling edge of the first clock signal terminal CK1, and the fourth sustain transistor T3 is turned off. The second clock signal terminal CK2 is at a high level, the second sustain transistor T4 is turned on, and the low level of the first power supply voltage terminal VGL is written into the second node N2.

In the fourth period P4, the first clock signal terminal CK1 is at a high level, the third sustain transistor T2 and the first sustain transistor T5 are turned on, the low level of the first node N1 is transmitted to the third node N3, and the fourth sustain transistor T3 is turned off. The first sustain transistor T5 is turned on, and each of the voltage of the first node N1 and the voltage of the second node N2 is at a low level.

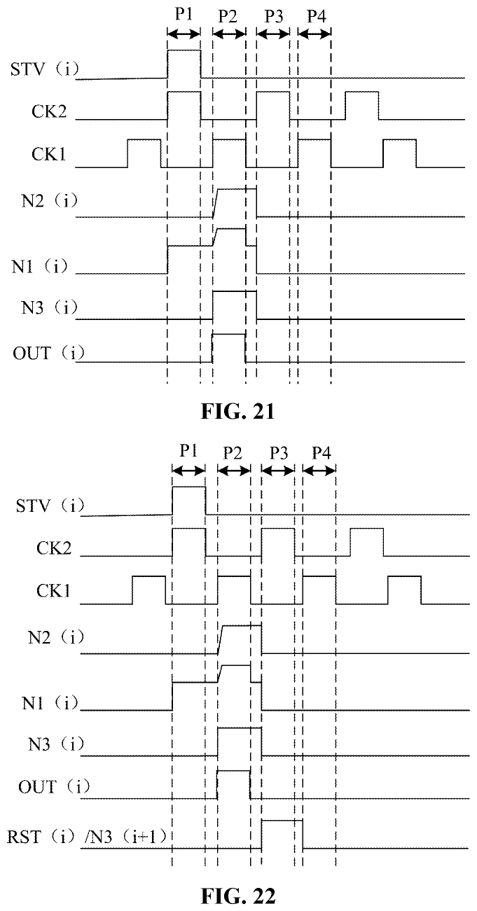

FIG. 21 is another driving timing diagram according to an embodiment of the present disclosure. Compared with the timing diagram shown in FIG. 17, the timing diagram of the reset signal terminal RST is omitted in FIG. 21. For similarities, reference can be made to the above description of the operation process of the shift register shown in FIG. 11, and the operation process of some transistors will be mainly described here.

Referring to FIGS. 13 and 21, in the first period P1, the first clock signal terminal CK1 is at a low level, and the third sustain transistor T2 and the first sustain transistor T5 are turned off. The second clock signal terminal CK2 is at a high level, the input transistor T1 is turned on, and the high level of the cascade signal input terminal STV is written to the first node N1. The second clock signal terminal CK2 is at a high level, the second sustain transistor T4 is turned on, and the low level of the first power supply voltage terminal VGL is transmitted to the second node N2. The reset transistor T9 is turned on, and the low level of the first power supply voltage terminal VGL is written to the third node N3. The third node N3 is not floating, and the reset transistor T9 keeps the voltage of the third node N3 at a low level. The fourth sustain transistor T3 is turned off.

In the second period P2, the first clock signal terminal CK1 is at a high level. However, the first sustain transistor T5 is at the off state since the first sustain transistor T5 is not turned on by the gate-source voltage difference of the first sustain transistor T5. The third sustain transistor T2 is turned on. The high level of the first node N1 is transmitted to the third node N3, the fourth sustain transistor T3 is turned on, the high level of the second power supply voltage terminal VGH is transmitted to the second node N2, and the voltage of the second node N2 is pulled up to a high level. The reset transistor T9 is turned off.

In the third period P3, the first clock signal terminal CK1 is at a low level, and the third sustain transistor T2 and the first sustain transistor T5 are turned off. The second clock signal terminal CK2 is at a high level, the reset transistor T9 is turned on, the low level of the first power supply voltage terminal VGL is written to the third node N3, and the voltage of the third node N3 is pulled down to a low level. The fourth sustain transistor T3 is turned off. The second clock signal terminal CK2 is at a high level, the second sustain transistor T4 is turned on, the low level of the first power supply voltage terminal VGL is written into the second node N2, and the voltage of the second node N2 is pulled down to a low level.

In the fourth period P4, the first clock signal terminal CK1 is at a high level, the third sustain transistor T2 and the first sustain transistor T5 are turned on, and the fourth sustain transistor T3 is turned off. The first sustain transistor T5 is turned on, and each of the voltage of the first node N1, the voltage of the second node N2 and the voltage of the third node N3 remains at a low level.

FIG. 22 is another driving timing diagram according to an embodiment of the present disclosure. Compared with the timing diagram shown in FIG. 17, in FIG. 22, the reset signal terminal RST of an i-th shift register 100 is connected to the third node N3 of an (i+1)-th shift register 100, and the timing of the reset signal terminal RST is modified. For similarities, reference can be made to the above description of the operation process of the shift register shown in FIG. 11, and the operation process of some transistors will be mainly described here.

Referring to FIGS. 14 and 22, in the third period P3, the first clock signal terminal CK1 is at a low level, and the third sustain transistor T2 and the first sustain transistor T5 are turned off. The reset signal terminal RST is at a high level, the reset transistor T9 is turned on, the low level of the first power supply voltage terminal VGL is written to the third node N3, and the voltage of the third node N3 is pulled down to a low level. The third node N3 is not floating. The fourth sustain transistor T3 is turned off. The second clock signal terminal CK2 is at a high level, the second sustain transistor T4 is turned on, the low level of the first power supply voltage terminal VGL is written into the second node N2, and the voltage of the second node N2 is pulled down to a low level.

In one or more embodiments, referring to FIGS. 2 to 18, the first branch transistor T21 and the second branch transistor T22 are oxide transistors, and the oxide transistors include an oxide semiconductor material. The oxide transistors may include, for example, indium gallium zinc oxide transistors, and may also include indium tin zinc oxide transistors, zirconium indium zinc oxide transistors, indium gallium oxide transistors or indium zinc oxide transistors. Therefore, the combination unit 20 including at least two oxide transistors is employed so that the duration of PBTS on the first branch transistor T21 and on the second branch transistor T22 is reduced, thereby prolonging the service life of the shift register and the service life of the gate driving circuit.

In one or more embodiments, referring to FIGS. 2 to 18, transistors in the shift register 100 include a first branch transistor T21 and a second branch transistor T22. All transistors in the shift register 100 are oxide transistors. The oxide transistor has advantages such as high mobility and low leakage current, thus improving the performance of the shift register 100 and the performance of the gate driving circuit.

In an example, referring to FIG. 11, the input transistor T1, the third sustain transistor T2, the fourth sustain transistor T3, the second sustain transistor T4, the first sustain transistor T5, the third output transistor T6, the second output transistor T7, the first output transistor T8 and the reset transistor T9 all employ oxide transistors. In other implementations, the shift register 100 may include oxide transistors and low-temperature polycrystalline silicon thin-film transistors. Alternatively, all transistors in the shift register 100 are low-temperature polycrystalline silicon thin-film transistors. Even for the low-temperature polycrystalline silicon thin-film transistors, the use of the combination unit 20 prolongs the service life of the low-temperature polycrystalline silicon thin-film transistors.

It should be further noted that each embodiment of the present disclosure takes an N-metal-oxide-semiconductor (NMOS) transistor as an example. For the NMOS transistor, under long-term PBTS, the threshold voltage experiences a positive drift. The high level is the effective level (or the enable level), and the NMOS transistor is turned on at the high level. However, those skilled in the art can also use a P-metal-oxide-semiconductor (PMOS) transistor as at least one transistor. For the PMOS transistor, under long-term NBTS, the threshold voltage experiences a negative drift. The low level is the effective level (or the enable level), and the PMOS transistor is turned on at the low level.

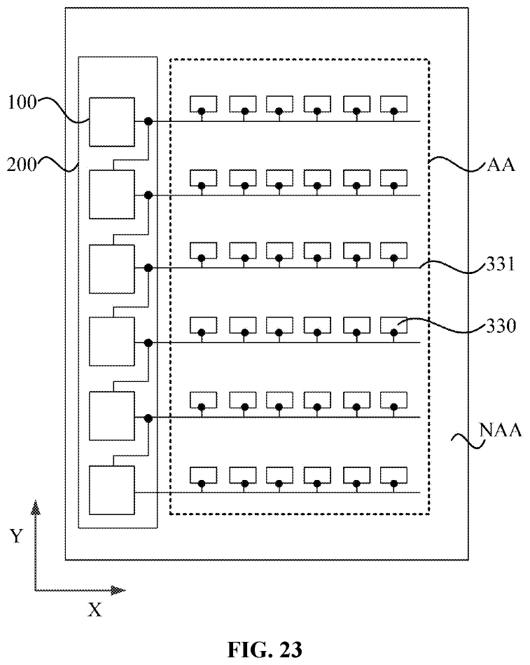

FIG. 23 is a schematic diagram of a display panel according to an embodiment of the present disclosure. Referring to FIG. 23, the display panel includes the gate driving circuit 200 in the above embodiments. Since the display panel according to the embodiments of the present disclosure includes the gate driving circuit 200 in the above embodiments, the multiple shift registers 100 in the gate driving circuit 200 can have a long service life.

In an example, referring to FIG. 23, the display panel includes a display area AA and a non-display area NAA, the gate driving circuit 200 is located in the non-display area NAA, and the pixel driving circuits 330 are located in the display area AA. Multiple pixel driving circuits 330 are disposed in an array along a first direction X and a second direction Y. The display panel further includes multiple scanning lines 331 extending along the first direction X and disposed along the second direction Y. The output signal terminal OUT of the shift register 100 is electrically connected to one scanning line 331. For example, the pixel driving circuit 330 may be a well-known pixel driving circuit in the art, such as a 2T1C or 7T1C pixel driving circuit, which will not be described in detail here.

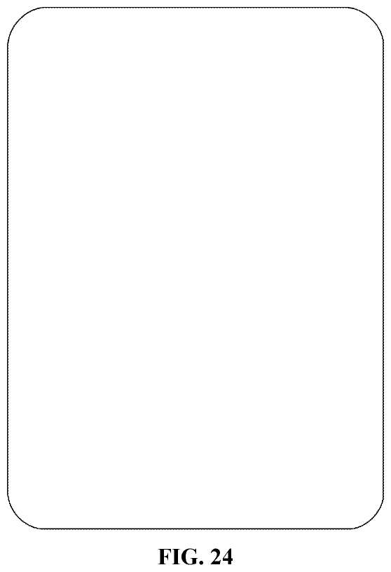

FIG. 24 is a schematic diagram of a display device according to an embodiment of the present disclosure. Referring to FIG. 24, the display device includes any display panel according to the embodiments of the present disclosure. Specifically, the display device may be a mobile phone, a tablet computer, a vehicle-mounted display device, an intelligent wearable device, etc.

Note that the above are only the exemplary embodiments of the present disclosure and the technical principles employed. Those skilled in the art will understand that the present disclosure is not limited to the specific embodiments described herein, and various obvious changes, readjustments, combinations and substitutions will be obvious to those skilled in the art without departing from the scope of protection of the present disclosure. Therefore, although the present disclosure has been described in detail through the above embodiments, the present disclosure is not limited to the above embodiments, but may include many other equivalent embodiments without departing from the concept of the present disclosure, and the scope of the present disclosure is determined by the scope of the appended claims.

What is claimed is:

1. A gate driving circuit, comprising a plurality of cascaded shift registers, wherein a shift register of the plurality of shift registers comprises an input unit, a sustain unit and an output unit;
an output terminal of the input unit and a first control terminal of the output unit are connected to a first node, a first terminal of the sustain unit is connected to the first node, and a second terminal of the sustain unit and an input terminal of the output unit are connected to a second node; and
at least one of the sustain unit or the output unit comprises a combination unit, the combination unit comprises a first branch transistor and a second branch transistor, a gate of the first branch transistor is connected to a first clock signal terminal, and a gate of the second branch transistor is connected to a second clock signal terminal.

2. The gate driving circuit according to claim 1, wherein a first electrode of the first branch transistor is coupled to a first electrode of the second branch transistor, and a second electrode of the second branch transistor is connected to a first power supply voltage terminal.

3. The gate driving circuit according to claim 2, wherein the output unit comprises a first output unit and a second output unit, and a control terminal of the first output unit is connected to the first node; and
the second output unit comprises a first output transistor and a second output transistor, the first output transistor is the first branch transistor, the second output transistor is the second branch transistor, and an output terminal of the first output unit, a first electrode of the first output transistor, and a first electrode of the second output transistor are connected to an output signal terminal.

4. The gate driving circuit according to claim 3, wherein a second electrode of the first output transistor is connected to the second node.

5. The gate driving circuit according to claim 3, wherein the first output unit comprises a third output transistor and a first capacitor, a gate of the third output transistor is connected to the first node, a first electrode of the third output transistor is connected to the first clock signal terminal, and a second electrode of the third output transistor is connected to the output signal terminal; a first plate of the first capacitor is connected to the first node, and a second plate of the first capacitor is connected to the output signal terminal.

6. The gate driving circuit according to claim 2, wherein the sustain unit comprises a first sustain unit;
the first sustain unit comprises a first sustain transistor and a second sustain transistor, the first sustain transistor is the first branch transistor, the second sustain transistor is the second branch transistor, and a first electrode of the first sustain transistor and a first electrode of the second sustain transistor are connected to the second node.

7. The gate driving circuit according to claim 6, wherein a second electrode of the first sustain transistor is coupled to the first node.

8. The gate driving circuit according to claim 7, wherein the first sustain unit further comprises a third sustain transistor, a first electrode of the third sustain transistor is connected to a third node, a second electrode of the third sustain transistor is connected to the first node, and a gate of the third sustain transistor is connected to the first clock signal terminal.

9. The gate driving circuit according to claim 8, wherein the second electrode of the first sustain transistor is connected to the third node.

10. The gate driving circuit according to claim 8, wherein the first sustain unit further comprises a reset transistor, a first electrode of the reset transistor is connected to the first power supply voltage terminal, and a second electrode of the reset transistor is connected to the third node.

11. The gate driving circuit according to claim 10, wherein among the plurality of shift registers, a gate of a reset transistor of an i-th shift register is connected to a third node of an (i+2)-th shift register, wherein i is a positive integer.

12. The gate driving circuit according to claim 10, wherein a gate of the reset transistor is connected to the second clock signal terminal.

13. The gate driving circuit according to claim 6, wherein the first sustain unit further comprises a second capacitor, a first plate of the second capacitor is connected to the first power supply voltage terminal, and a second plate of the second capacitor is connected to the second node.

14. The gate driving circuit according to claim 6, wherein the sustain unit further comprises a second sustain unit, a control terminal of the second sustain unit is coupled to the first node, an input terminal of the second sustain unit is connected to a second power supply voltage terminal, and an output terminal of the second sustain unit is coupled to the second node.

15. The gate driving circuit according to claim 14, wherein the second sustain unit comprises a fourth sustain transistor, a gate of the fourth sustain transistor is connected to the first node, a first electrode of the fourth sustain transistor is connected to the second power supply voltage terminal, and a second electrode of the fourth sustain transistor and a second electrode of the first sustain transistor are connected to a third node.

16. The gate driving circuit according to claim 14, wherein the second sustain unit comprises a fourth sustain transistor, a gate of the fourth sustain transistor is connected to a third node, a first electrode of the fourth sustain transistor is connected to the second power supply voltage terminal, and a second electrode of the fourth sustain transistor and the first electrode of the first sustain transistor are connected to the second node.

17. The gate driving circuit according to claim 1, wherein an input terminal of the input unit is connected to a cascade signal input terminal, and a control terminal of the input unit is connected to the second clock signal terminal; and
among the plurality of shift registers, an output signal terminal of an i-th shift register is connected to a cascade signal input terminal of an (i+1)-th shift register, wherein i is a positive integer.

18. The gate driving circuit according to claim 17, wherein the input unit comprises an input transistor, a gate of the input transistor is connected to the second clock signal terminal, a first electrode of the input transistor is connected to the cascaded signal input terminal, and a second electrode of the input transistor is connected to the first node.

19. The gate driving circuit according to claim 1, further comprising a first clock signal line and a second clock signal line; wherein among the plurality of shift registers,
the first clock signal line is electrically connected to a first clock signal terminal of an i-th shift register and a second clock signal terminal of an (i+1)-th shift register, and
the second clock signal line is electrically connected to a second clock signal terminal of the i-th shift register and a first clock signal terminal of the (i+1)-th shift register; wherein i is a positive integer.

20. The gate driving circuit according to claim 1, wherein the first branch transistor and the second branch transistor are oxide transistors comprising an oxide semiconductor material.

21. The gate driving circuit according to claim 20, wherein all transistors in the shift register are oxide transistors.

22. A gate driving circuit, comprising a plurality of cascaded shift registers, wherein a shift register of the plurality of shift registers comprises an input unit, a sustain unit, and an output unit;
an output terminal of the input unit and a first control terminal of the output unit are connected to a first node, a first terminal of the sustain unit is connected to the first node, and a second terminal of the sustain unit and an input terminal of the output unit are connected to a second node; and
any one of the input unit, the sustain unit, and the output unit comprises at least one transistor, and in the shift register, a quantity proportion of transistors whose gates are connected to clock signal terminals exceeds 50%.

23. A display panel comprising a gate driving circuit, wherein the gate driving circuit comprises a plurality of cascaded shift registers, wherein a shift register of the plurality of shift registers comprises an input unit, a sustain unit and an output unit;
an output terminal of the input unit and a first control terminal of the output unit are connected to a first node, a first terminal of the sustain unit is connected to the first node, and a second terminal of the sustain unit and an input terminal of the output unit are connected to a second node; and
at least one of the sustain unit or the output unit comprises a combination unit, the combination unit comprises a first branch transistor and a second branch transistor, a gate of the first branch transistor is connected to a first clock signal terminal, and a gate of the second branch transistor is connected to a second clock signal terminal.
